(19) United States
(12) Patent Application Publication
(10) Pub. No.: US 2014/0044628 A1
(43) Pub. Date: Feb. 13, 2014

(54) COMPOSITION BASED ON OXIDES OF ZIRCONIUM, OF CERIUM, OF AT LEAST ONE RARE EARTH OTHER THAN CERIUM AND OF SILICON, PREPARATION PROCESSES AND USE IN CATALYSIS

(71) Applicant: Simon Ifrah, Lagord (FR)

(72) Inventor: Simon Ifrah, Lagord (FR)

(73) Assignee: RHODIA OPERATIONS, Aubervilliers (FR)

(21) Appl. No.: 14/110,374

(22) PCT Filed: Apr. 4, 2012
(86) PCT No.: PCT/EP12/56165

§ 371 Date: Oct. 28, 2013

(30) Foreign Application Priority Data
Apr. 8, 2011 (FR) 11/01092

(51) Int. Cl. B01J 23/10; B01D 53/94

(52) U.S. Cl. CPC B01J 23/10; B01D 53/945
USPC 423/213.2; 502/304; 502/242

(57) ABSTRACT

The composition according to the invention is based on zirconium oxide, cerium oxide and at least one oxide of a rare earth other than cerium, in a proportion, by weight, of zirconium oxide of at least 5% and of cerium oxide of at most 90%, and it is characterized in that it additionally comprises silicon oxide in an amount, by weight, of between 0.1% and 2%. This composition may be used in catalysis, in particular in systems for treating the exhaust gases of internal combustion engines.

The present invention relates to a composition based on zirconium oxide, on cerium oxide, on at least one oxide of a rare earth metal other than cerium and on silicon oxide, to its processes of preparation and to its use in catalysis.

“Multifunctional” catalysts are currently used for the treatment of exhaust gases from internal combustion engines (automobile afterburning catalysis).

Multifunctional is understood to mean catalysts capable of carrying out not only oxidation, in particular of carbon monoxide and hydrocarbons present in exhaust gases, but also reduction, in particular of nitrogen oxides also present in these gases (“three-way” catalysts). Zirconium oxide and cerium oxide today appear as two particularly important and advantageous constituents for catalysts of this type. A required quality for these materials is their reducibility. Reducibility is understood to mean, here and for the remainder of the description, the content of cerium(IV) in these materials capable of being converted into cerium(III) under the effect of a reducing atmosphere and at a given temperature. This reducibility can be measured, for example, by a consumption of hydrogen within a given temperature range. It is due to the cerium, which has the property of being reduced or of being oxidized. This reducibility should, of course, be as high as possible.

In addition, it is important for this reducibility to retain a sufficiently high value for the products to remain effective even after exposure of the latter to high temperatures.

An object of the invention is to provide a product which exhibits satisfactory reducibility properties within a temperature range which remains fairly high.

With this aim, the composition according to the invention is based on zirconium oxide, on cerium oxide and on at least one oxide of a rare earth metal other than cerium, in a proportion by weight of zirconium oxide of at least 5% and of cerium oxide of at most 90%, and it is characterized in that it additionally comprises silicon oxide in an amount by weight of between 0.1% and 2%.

Other characteristics, details and advantages of the invention will become even more fully apparent on reading the description which will follow and various concrete but non-limiting examples intended to illustrate it.

For the continuation of the description, specific surface is understood to mean the BET specific surface determined by nitrogen adsorption in accordance with the standard ASTM D 3663-78 drawn up from the Brunauer-Emmett-Teller method described in the periodical The Journal of the American Chemical Society, 60, 309 (1938).

For the present description, rare earth metal is understood to mean the elements of the group consisting of yttrium and the elements of the Periodic Table with an atomic number between 57 and 71 inclusive.

In addition, the calcinations for a given temperature and a given duration correspond, unless otherwise indicated, to calcinations under air at a stationary temperature phase over the duration indicated. The contents are given as weight of oxide, unless otherwise indicated.

The cerium oxide is in the form of ceric oxide and the oxides of the other rare earth metals are in the form Ln₂O₃, Ln denoting the rare earth metal, with the exception of praseodymium, expressed in the form Pr₆O₁₁.

It is specified, for the continuation of the description, that, unless otherwise indicated, in the ranges of values which are given, the values at the limits are included.

The compositions according to the invention are characterized first of all by the nature of their constituents.

The compositions of the invention are based on zirconium oxide and on cerium oxide and they additionally comprise at least one oxide of at least one other rare earth metal which is different from cerium, and also silicon oxide (SiO₂).

According to an advantageous embodiment of the invention, the compositions comprise at least two oxides of rare earth metals other than cerium.

The rare earth metal or metals other than cerium can more particularly be chosen from yttrium, lanthanum, neodymium, praseodymium or gadolinium. Mention may more particularly be made of the compositions based on oxides of zirconium, cerium, praseodymium and lanthanum or else based on oxides of zirconium, cerium, yttrium, neodymium and lanthanum.

As indicated above, the amount of silicon oxide in the compositions of the invention is between 0.1% and 2%. Below 0.1%, the presence of silicon no longer plays a role with regard to the properties of the compositions and, beyond 2%, the specific surface of the compositions may not be sufficiently stable at elevated temperature for uses in the field of catalysis.

This amount of silicon oxide can more particularly be between 0.1% and 1% and more particularly still between 0.1% and 0.6%.

According to a preferred embodiment, this amount can be between 0.2% and 0.5%.

The content of cerium oxide is at most 90% and more particularly at most 60%. The minimum amount of cerium is not critical. Preferably, however, it is at least 0.1% and more particularly at least 1% and more particularly still at least 5%.

According to the embodiments, this content can be between 5% and 20% or between 30% and 60%. In the case of compositions having a high cerium content, the amount of cerium can be at least 70%.

The content as oxide of the rare earth metal or metals other than cerium is generally at most 30%, more particularly at most 25%, and at least 4%, preferably at least 5% and in particular at least 10%. It can in particular be between 5% and 25% and more particularly still between 5% and 20%.

According to the embodiments, the zirconium oxide content can more particularly be between 15% and 65% or between 60% and 90%.

According to a specific embodiment, the compositions of the invention essentially comprise zirconium oxide, cerium oxide, silicon oxide and one or more oxides of a rare earth metal other than cerium in the proportions given above. “Essentially comprise” is understood to mean that, apart from the usual impurities which may originate from its preparation process, for example from the starting materials or starting reactants used, the composition does not comprise other elements capable of having an effect on its specific surface or reducibility characteristics.

The compositions of the invention exhibit high specific surfaces, even after calcination at high temperature.

Thus, they can exhibit a specific surface, after calcination for 4 hours at 1000° C., of at least 30 m²/g, preferably of at least 35 m²/g and more preferably still of at least 40 m²/g. Surface values ranging up to approximately 45 m²/g, indeed even 50 m²/g, can be achieved.

The compositions of the invention can also exhibit a specific surface, after calcination for 4 hours at 1100° C., of at least 10 m²/g, it being possible for this surface to even be at least 15 m²/g. Surface values ranging up to approximately 21 m²/g, indeed even 24 m²/g, can be achieved under these same calcination conditions.

The compositions of the invention can be provided in the form of pure solid solutions of the elements zirconium, cerium, rare earth metal(s) other than cerium and silicon in the cerium or zirconium oxide, as a function of the respective contents of these two elements.

In this case, the X-ray diffraction diagrams of these competitions reveal the existence of a single phase corresponding to that of a zirconium oxide (for the compositions having a higher zirconium content) or a cerium oxide (for the compositions having a higher cerium content), crystallized in the cubic or quadratic system, thus reflecting the incorporation of the elements zirconium, cerium, rare earth metals other than cerium and silicon in the crystal lattice of the cerium oxide or zirconium oxide and thus the achievement of a true solid solution. This embodiment, a solid solution, applies to compositions which have been subjected to a calcination at a temperature as high as 1100° C. and for 4 hours. This means that, after calcination under these conditions, phase separation, that is to say the appearance of other phases, is not observed.

Another characteristic of the compositions of the invention is their oxygen storage capacity (OSC).

For the entire description, the OSC values which are given correspond to capacities measured between 400° C. and 500° C.

The compositions of the invention specifically exhibit a high OSC at high temperatures, that is to say up to 1000° C., which makes it possible to use these compositions in catalysis applications at least up to this temperature.

This capacity depends on the amount of cerium in the compositions.

For cerium oxide contents which are between 5% and 15% or at least 70% and for compositions which have furthermore been subjected to a calcination at 1000° C. for 4 hours, this OSC is at least 0.20 ml of O₂/g. It can more particularly be at least 0.25 ml of O₂/g. Values up to approximately 0.4 ml of O₂/g can be obtained.

For cerium oxide contents which are between 30% and 60% and still for compositions which have been subjected to a calcination at 1000° C. for 4 hours, this OSC is at least 0.6 ml of O₂/g, more particularly at least 0.7 ml of O₂/g. Values up to approximately 0.95 ml of O₂/g can be obtained.

In contrast, the compositions of the invention exhibit a significant fall in their OSC and more generally in their reducibility property at higher temperature, that is to say, starting from 1200° C. Thus, after calcination for 10 hours at 1200° C., they exhibit a decrease in their OSC (expressed by the ratio as % (OSC after calcination for 4 hours at 1000° C.-OSC after calcination at 1200° C.)/OSC after calcination for 4 hours at 1000° C.) of at least 80%, more particularly of at least 90%.

For cerium oxide contents which are between 5% and 15% or at least 70% and for compositions which have been subjected to a calcination for 10 hours at 1200° C., this OSC is at most 0.1 ml of O₂/g, more particularly at most 0.05 ml of O₂/g, and more particularly still this value can be zero.

For cerium oxide contents which are between 30% and 60% and for compositions which have been subjected to a calcination under the same conditions, this OSC is at most 0.15 ml of O₂/g, more particularly at most 0.10 ml of O₂/g.

This significant fall in the OSC makes it possible to use the compositions of the invention in on-board diagnostic (OBD) systems which will be described later.

Another characteristic of the compositions of the invention is their reducibility. This reducibility is determined by the measurement of their hydrogen scavenging capacity as a function of the temperature. A maximum reducibility temperature (Tmax), which corresponds to the temperature at which the hydrogen scavenging is maximum and where, in other words, the reduction of the cerium(IV) to give cerium(III) is also maximum, is also determined by this measurement.

The compositions of the invention have the characteristic of exhibiting a high variation in their Tmax between 1000° C. and 1200° C. More specifically, these compositions can exhibit, after calcination for 4 hours at 1000° C., followed by calcination for 10 hours at 1200° C., a displacement or an increase in their maximum reducibility temperature by an amplitude of at least 150° C., more particularly of at least 170° C. and more particularly still of at least 200° C.

Generally, the Tmax of the compositions of the invention is between 550° C. and 580° C. after calcination for 4 hours at 1000° C. and it is between 750° C. and 850° C. after calcination for 10 hours at 1200° C.

The processes for the preparation of the compositions of the invention will now be described.

According to a first embodiment, the invention relates to a process which comprises the following stages:

(a1) a mixture is formed comprising compounds of zirconium, of cerium, of at least one rare earth metal other than cerium and of silicon;

(b1) said mixture is brought together with a basic compound, whereby a precipitate is obtained;

(c1) said precipitate is heated in a liquid medium;

(d1) an additive chosen from anionic surfactants, non-ionic surfactants, polyethylene glycols, carboxylic acids and their salts, and surfactants of the carboxymethylated fatty alcohol ethoxylate type is added to the precipitate obtained in the preceding stage;

(e1) the product thus obtained is calcined.

The first stage (a1) of the process thus consists in preparing a mixture of the compounds of the constituent elements of the composition which it is desired to prepare. The mixing is generally carried out in a liquid medium which is preferably water.

The compounds are preferably soluble compounds. They can in particular be salts of zirconium, cerium and rare earth metal. These compounds can be chosen from nitrates, sulfates, acetates, chlorides, ceric nitrate or ceric ammonium nitrate.

Mention may thus be made, as examples, of zirconium sulfate, zirconyl nitrate or zirconyl chloride.

The zirconyl sulfate may originate from the dissolution of crystalline zirconyl sulfate. It may also have been obtained by dissolution of basic zirconium sulfate with sulfuric acid, or else by dissolution of zirconium hydroxide with sulfuric acid. In the same way, the zirconyl nitrate may originate from the dissolution of crystalline zirconyl nitrate or else it may have been obtained by dissolution of basic zirconium carbonate or also by dissolution of zirconium hydroxide by nitric acid.

It is advantageous to use salts with a purity of at least 99.5% and more particularly of at least 99.9%.

It can be advantageous to use a zirconium compound in the form of a combination or of a mixture of the abovementioned salts. Mention may be made, for example, of the combination of zirconium nitrate with zirconium sulfate, or also the combination of zirconium sulfate with zirconyl chloride. The respective proportions of the various salts can vary within wide limits, from 90/10 up to 10/90, for example, these proportions denoting the contribution of each of the salts in grams of total zirconium oxide.

It should be noted that, when the starting mixture comprises cerium in the III form, it is preferable to involve an oxidizing agent, for example hydrogen peroxide, in the course of the process. This oxidizing agent can be used by being added to the reaction mixture during stage (a1), during stage (b1) or also at the start of stage (c1).

Finally, it is also possible to use a sol as starting compound for the zirconium or cerium. Sol denotes any system consisting of fine solid particles of colloidal dimensions, that is to say dimensions between approximately 1 nm and approximately 200 nm, based on a zirconium or cerium compound, this compound generally being a zirconium or cerium oxide and/or a hydrated zirconium or cerium oxide, in suspension in an aqueous liquid phase.

The sols or colloidal dispersions used can be stabilized by the addition of stabilizing ions.

These colloidal dispersions can be obtained by any means known to a person skilled in the art. In particular, mention may be made of the partial dissolution of zirconium precursor. Partial is understood to mean that the amount of acid employed in the reaction in which the precursor is attacked is less than the amount required for the complete dissolution of the precursor.

The colloidal dispersions can also be obtained by hydrothermal treatment of solutions of zirconium or cerium precursors.

Recourse may be had, as silicon compound, to siliconates or else to alkali metal or quaternary ammonium silicates. Mention may more particularly be made, among the siliconates, of alkali metal alkyl siliconates, such as, for example, potassium methyl siliconate, and, for alkali metal silicates, of sodium silicate.

The quaternary ammonium ion of the silicates which can be employed according to the invention exhibits hydrocarbon radicals preferably having from 1 to 3 carbon atoms. Use is thus preferably made of at least one silicate chosen from tetramethylammonium silicate, tetraethylammonium silicate, tetrapropylammonium silicate or tetrahydroxyethylammonium silicate (or tetraethanolammonium silicate). Tetramethylammonium silicate is described in particular in Y.U.I. Smolin, “Structure of water soluble silicates with complex cations”, in “Soluble Silicates”, Edition 1982. Tetraethanolammonium silicate is described in particular in Helmut H. Weldes and K. Robert Lange, “Properties of soluble silicates”, in “Industrial and Engineering Chemistry”, vol. 61, N4, April 1969, and in the U.S. Pat. No. 3,239,521. The abovementioned references also describe other water-soluble quaternary ammonium silicates which can be used according to the invention.

The mixture of stage (a1) can be obtained without distinction either from compounds initially in the solid state, which will be subsequently introduced into a water vessel heel, for example, or also directly from solutions or suspensions of these compounds and then mixing, in any order, said solutions or suspensions. The compounds of zirconium, of cerium, of the rare earth metals other than cerium and of silicon are present in the stoichiometric amounts necessary.

In the second stage (b1) of the process, said mixture is brought together with a basic compound in order to cause them to react. Use may be made, as base or basic compound, of the products of the hydroxide type. Mention may be made of alkali metal or alkaline earth metal hydroxides. Use may also be made of secondary, tertiary or quaternary amines. However, the amines and ammonia may be preferred insofar as they reduce the risks of contamination by alkali metal or alkaline earth metal cations. Mention may also be made of urea.

The basic compound can more particularly be used in the form of a solution. Finally, it can be used with a stoichiometric excess in order to provide for optimum precipitation.

This operation of bringing together is generally carried out with stirring. It can be carried out in any way, for example by the addition of a preformed mixture of the compounds of the abovementioned elements to the basic compound in the form of a solution. A precipitate is obtained on conclusion of this stage (b1).

The following stage (c1) of the process is the stage of heating this precipitate in a liquid medium. It may be noted that, at the start of this stage, the pH of this medium is basic and that it is generally at least 8.

This heating can be carried out directly on the reaction medium obtained on conclusion of stage (b1) or on a suspension obtained after separating the precipitate from the reaction medium, optional washing of the precipitate and placing the precipitate back in water. The temperature to which the medium is heated is at least 100° C. and more particularly still at least 110° C. It can, for example, be between 100° C. and 160° C. The heating operation can be carried out by introducing the liquid medium into a closed chamber (closed reactor of the autoclave type). Under the temperature conditions given above, and in an aqueous medium, it may thus be specified, by way of illustration, that the pressure in the closed reactor can vary between a value greater than 1 bar (10⁵ Pa) and 165 bar (1.65×10⁷ Pa), preferably between 5 bar (5×10⁵ Pa) and 165 bar (1.65×10⁷ Pa). It is also possible to carry out the heating in an open reactor for temperatures in the vicinity of 100° C.

The heating can be carried out either under air or under an inert gas atmosphere, preferably nitrogen.

The duration of the heating can vary within wide limits, for example between 30 minutes and 48 hours, preferably between 2 and 24 hours. Likewise, the rise in temperature is produced at a rate which is not critical and it is thus possible to reach the set reaction temperature by heating the medium, for example, for between 30 minutes and 4 hours, these values being given entirely by way of indication.

It is possible to carry out several heating operations. Thus, the precipitate obtained after the heating stage and optionally a washing operation can be resuspended in water and then another heating operation can be carried out on the medium thus obtained. This other heating operation is carried out under the same conditions as those which were described for the first.

The following stage (d1) of the process consists in adding, to the precipitate resulting from the preceding stage, an additive which is chosen from anionic surfactants, non-ionic surfactants, polyethylene glycols, carboxylic acids and their salts, and also surfactants of the carboxymethylated fatty alcohol ethoxylate type.

As regards this additive, reference may be made to the teaching of the application WO-98/45212 and the surfactants described in this document can be used.

Mention may be made, as surfactants of the anionic type, of ethoxycarboxylates, ethoxylated fatty acids, sarcosinates, phosphate esters, sulfates, such as alcohol sulfates, alcohol ether sulfates and sulfated alkanolamide ethoxylates, or sulfonates, such as sulfosuccinates, alkylbenzenesulfonates or alkylnaphthalenesulfonates.

Mention may be made, as non-ionic surfactants, of acetylenic surfactants, alcohol ethoxylates, alkanolamides, amine oxides, ethoxylated alkanolamides, long-chain ethoxylated amines, ethylene oxide/propylene oxide copolymers, sorbitan derivatives, ethylene glycol, propylene glycol, glycerol, polyglyceryl esters and their ethoxylated derivatives, alkylamines, alkylimidazolines, ethoxylated oils and alkylphenol ethoxylates. Mention may in particular be made of the products sold under the Igepal®, Dowanol®, Rhodamox® and Alkamide® brands.

As regards the carboxylic acids, use may in particular be made of aliphatic mono- or dicarboxylic acids and, among these, more particularly of saturated acids. Use may also be made of fatty acids and more particularly of saturated fatty acids. Mention may thus in particular be made of formic, acetic, propionic, butyric, isobutyric, valeric, caproic, caprylic, capric, lauric, myristic or palmitic acid. Mention may be made, as dicarboxylic acids, of oxalic, malonic, succinic, glutaric, adipic, pimelic, suberic, azelaic and sebacic acids.

The salts of the carboxylic acids can also be used, in particular the ammonium salts.

Mention may more particularly be made, as example, of lauric acid and ammonium laurate.

Finally, it is possible to use a surfactant which is chosen from those of the carboxymethylated fatty alcohol ethoxylate type.

Product of the carboxymethylated fatty alcohol ethoxylate type is understood to mean the products composed of ethoxylated or propoxylated fatty alcohols comprising, at the chain end, a CH₂—COOH group.

These products can correspond to the formula:

R₁—O—(CR₂R₃—CR₄R₅—O)ₙ—CH₂—COOH

in which R₁ denotes a saturated or unsaturated carbon chain, the length of which is generally at most 22 carbon atoms, preferably at least 12 carbon atoms; R₂, R₃, R₄ and R₅ can be identical and represent hydrogen or else R₂ can represent a CH₃ group and R₃, R₄ and R₅ represent hydrogen; and n is a non-zero integer which can range up to 50 and more particularly between 5 and 15, these values being inclusive. It should be noted that a surfactant can be composed of a mixture of products of the above formula for which R₁ can be saturated or unsaturated respectively or else products comprising both —CH₂—CH₂—O— and —C(CH₃)—CH₂—O— groups.

The addition of the surfactant can be carried out in two ways. It can be added directly to the precipitate suspension resulting from the preceding heating stage (c1). It can also be added to the solid precipitate after separation of the latter by any known means from the medium in which the heating took place.

The amount of surfactant used, expressed as percentage by weight of additive with respect to the weight of the composition, calculated as oxide, is generally between 5% and 100%, more particularly between 15% and 60%.

According to another advantageous alternative form of the invention, before carrying out the final stage of the process (calcination stage), the precipitate is washed after having separated it from the medium in which it occurred in suspension. This washing operation can be carried out with water, preferably with water at basic pH, for example aqueous ammonia solution.

In a final stage (e1) of the process according to the invention, the precipitate recovered is subsequently calcined. This calcination makes it possible to develop the crystallinity of the product formed and it can also be adjusted and/or chosen according to the subsequent operating temperature intended for the composition according to the invention, this being done while taking into account the fact that the specific surface of the product decreases as the calcination temperature employed increases. Such a calcination is generally carried out under air but a calcination carried out, for example, under an inert gas or under a controlled atmosphere (oxidizing or reducing) is very clearly not excluded.

In practice, the calcination temperature is generally restricted to a range of values between 500° C. and 900° C., more particularly between 700° C. and 800° C.

The process for the preparation of the compositions of the invention can be carried out according to a second embodiment.

In this case, the process comprises the first three following stages:

(a2) a mixture is formed comprising compounds of zirconium, of cerium and of the rare earth metals other than cerium;

(b2) said mixture is brought together with a basic compound, whereby a precipitate is obtained;

(c2) said precipitate is heated in a liquid medium.

Stages (a2), (b2) and (c2) of this second form are identical respectively to stages (a1), (b1) and (c1) described for the first form. The only difference is that the starting mixture of stage (a1) does not comprise a silicon compound, this compound being added subsequently. Apart from this difference, that which was described above for stages (a1), (b1) and (c1) likewise applies for stages (a2), (b2) and (c2).

The process according to the second form subsequently comprises a stage (d2) in which a silicon compound is added, in the stoichiometric amounts necessary, to the precipitate obtained in the preceding stage (c2). This silicon compound is of the same type as that which was described above.

Finally, the process comprises two other stages, a stage (e2) in which an additive of the same type as that used in stage (d1) of the process according to the first form is added to the product obtained in the preceding stage, and a stage (f2) in which the product thus obtained is calcined.

The conditions for carrying out stages (e2) and (f2) are the same as those given for stages (d1) and (e1) of the first process.

It may be noted here that it is possible to carry out the two stages (d2) and (e2) at the same time, that is to say to simultaneously add the silicon compound and the additive to the precipitate resulting from stage (c2).

According to a third embodiment, the compositions of the invention can be prepared by a process which comprises the following stages:

(a3) a mixture is formed comprising compounds of zirconium, of cerium and of at least one rare earth metal other than cerium and optionally a silicon compound;

(b3) said precipitate is heated in a liquid medium;

(c3) a silicon compound, if the latter was not present in stage (a3), is added to the precipitate obtained in the preceding stage;

(d3) an additive chosen from anionic surfactants, non-ionic surfactants, polyethylene glycols, carboxylic acids and their salts, and surfactants of the carboxymethylated fatty alcohol ethoxylate type is added to the product obtained in the preceding stage;

(e3) the product thus obtained is calcined.

Stage (a3) of this third form is similar to stage (a1) described above. However, it should be noted that the silicon compound may or may not be present in this stage.

Contrary to the preceding embodiments, the process according to the third form does not employ a basic compound. It comprises a stage (b3) of heating the mixture prepared during the preceding stage, this heating being carried out in a liquid medium, this medium being acidic at the start of stage (b3), for example at a pH of less than 4.

The temperature at which this heat treatment is carried out, also known as thermal hydrolysis, is at least 100° C. It can thus be between 100° C. and the critical temperature of the reaction medium, in particular between 100° C. and 350° C., preferably between 100° C. and 200° C.

The heating operation can be carried out by introducing the liquid medium into a closed chamber (closed chamber of the autoclave type), the necessary pressure then resulting only from the heating alone of the reaction medium (autogenous pressure). Under the temperature conditions given above, and in aqueous media, it may thus be specified, by way of illustration, that the pressure in the closed reactor can vary between a value greater than 1 bar (10⁵ Pa) and 165 bar (1.65×10⁷ Pa), preferably between 5 bar (5×10⁵ Pa) and 165 bar (1.65×10⁷ Pa). It is, of course, also possible to exert an external pressure which then adds to that resulting from the heating.

It is also possible to carry out the heating in an open reactor for temperatures in the vicinity of 100° C.

The heating can be carried out either under air or under an inert gas atmosphere, preferably nitrogen.

The duration of the treatment is not critical and can thus vary within wide limits, for example between 30 minutes and 48 hours, preferably between 1 and 5 hours. Likewise, the rise in temperature is produced at a rate which is not critical and it is thus possible to reach the set reaction temperature by heating the medium, for example, for between 30 minutes and 4 hours, these values being given entirely by way of indication.

On conclusion of the heating, a precipitate is obtained which is separated from the liquid medium by any suitable means.

The following stage (c3) consists in adding the silicon compound to the precipitate thus obtained, in the case where the silicon compound was not introduced during stage (a3).

Stages (d3) and (e3) are identical to stages (d1) and (c1) described above.

It may be noted that, here again, it is possible to carry out the two stages (c3) and (d3) at the same time, that is to say to simultaneously add the silicon compound and the additive to the precipitate resulting from stage (b3).

A fourth embodiment of the process for the preparation of the compositions of the invention will also be described below.

The process according to this last form comprises the following stages:

(a4) a mixture is formed comprising compounds of zirconium, of cerium and of silicon only or these compounds with one or more compounds of rare earth metals other than cerium in an amount of this or these latter compound(s) which is less than the amount necessary to obtain the desired composition;

(b4) said mixture is brought together, with stirring, with a basic compound;

(c4) the mixture obtained in the preceding stage is brought together, with stirring, either with the compound or compounds of rare earth metals other than cerium, if this or these compounds were not present in stage (a4), or with the remaining amount of said compound or compounds which is necessary, the stirring energy used during stage (c4) being less than that used during stage (b4), whereby a precipitate is obtained;

(d4) said precipitate is heated in an aqueous medium;

(e4) an additive chosen from anionic surfactants, non-ionic surfactants, polyethylene glycols, carboxylic acids and their salts, and surfactants of the carboxymethylated fatty alcohol ethoxylate type is added to the precipitate obtained in the preceding stage;

(f4) the precipitate thus obtained is calcined.

Stages (a4) and (b4) of this process are entirely analogous to stages (a1) and (b1) of the first form and that which was described with regard to them thus likewise applies here. The difference lies in the fact that the mixture formed in stage (a4) comprises, as regards the constituent elements of the composition, that is to say zirconium, cerium, silicon and other rare earth metal(s), only the compounds of zirconium, cerium and silicon in a first alternative form.

According to a second alternative form, the mixture formed in stage (a4) comprises, in addition to the compounds of zirconium, of cerium and of silicon, the compound or compounds of the other rare earth metals other than cerium but in an amount which is less than the total stoichiometric amount of this or these compounds of other rare earth metals necessary in order to obtain the desired composition. This amount can more particularly be at most equal to half of the total amount.

It will be noted that this second alternative form should be understood as covering the case, for the compositions based on oxides of zirconium, of cerium, of silicon and of at least two other rare earth metals, where, in stage (a4), the total necessary amount of compound of at least one of the rare earth metals is present from this stage and where it is only for at least one of the other remaining rare earth metals that the amount of the compound of this other rare earth metal is less than the necessary amount. It is also possible for the compound of this other rare earth metal to be absent in this stage (a4).

The following stage (c4) of the process consists in bringing together the medium resulting from the preceding stage (b4) with the compounds of the rare earth metals other than cerium. In the case of the first alternative form mentioned above, in which the starting mixture formed in stage (a4) comprises, as constituent elements of the composition, only compounds of zirconium, of cerium and of silicon, these compounds are thus introduced for the first time into the process and in the necessary total stoichiometric amount of these other rare earth metals. In the case of the second alternative form, in which the mixture formed in stage (a4) already comprises compounds of the other rare earth metals other than cerium, it thus concerns the necessary remaining amount of these compounds or, optionally, the necessary amount of the compound of a rare earth metal if this compound was not present in stage (a4).

This operation of bringing together can be carried out in any way, for example by the addition of a preformed mixture of the compounds of the rare earth metals other than cerium to the mixture obtained on conclusion of stage (b4). It is also carried out with stirring but under conditions such that the stirring energy used during this stage (c4) is less than that used during stage (b4). More specifically, the energy employed during stage (c4) is less by at least 20% than that of stage (b4) and it can more particularly be less than 40% and more particularly still than 50% of this.

On conclusion of stage (c4), a precipitate in suspension in the reaction medium is obtained.

The following stages (d4), (e4) and (f4) are subsequently identical to stages (c1), (d1) and (e1) respectively of the process according to the first form.

The process according to the fourth embodiment makes it possible to obtain products having an improved stability of the specific surface.

The compositions of the invention, as described above or as obtained by the preparation processes described above, are provided in the form of powders but they can optionally be shaped in order to be provided in the form of granules, beads, cylinders or honeycombs of variable dimensions.

These compositions can be used with any material commonly employed in the field of catalyst formulation, that is to say in particular thermally inert materials. This material can be chosen from alumina, titanium oxide, cerium oxide, zirconium oxide, silica, spinels, zeolites, silicates, crystalline silicoaluminum phosphates or crystalline aluminum phosphates.

The compositions can also be used in catalytic systems comprising a coating (wash coat) having catalytic properties and based on these compositions with a material of the type of those mentioned above, the coating being deposited on a substrate of the, for example, metal monolith type, for example FeCralloy, or made of ceramic, for example of cordierite, of silicon carbide, of alumina titanate or of mullite.

This coating is obtained by mixing the composition with the material, so as to form a suspension which can subsequently be deposited on the substrate.

These catalytic systems and more particularly the compositions of the invention can have a great many applications.

They are therefore particularly well-suited to, and thus usable in, the catalysis of various reactions, such as, for example, dehydration, hydrosulfurization, hydrodenitrification, desulfurization, hydrodesulfurization, dehydrohalogenation, reforming, steam reforming, cracking, hydrocracking, hydrogenation, dehydrogenation, isomerization, dismutation, oxychlorination, dehydrocyclization of hydrocarbons or other organic compounds, oxidation and/or reduction reactions, the Claus reaction, treatment of exhaust gases from internal combustion engines, demetallation, methanation, the shift conversion or catalytic oxidation of the soot emitted by internal combustion engines, such as diesel engines or petrol engines operating under lean burn conditions.

The catalytic systems and the compositions of the invention can finally be used as NOx traps or for promoting the reduction of NOx, even in an oxidizing environment.

In the case of these uses in catalysis, the compositions of the invention are employed in combination with precious metals; they thus act as support for these metals. The nature of these metals and the techniques for the incorporation of the latter in the support compositions are well-known to a person skilled in the art. For example, the metals can be platinum, rhodium, palladium or iridium; they can in particular be incorporated in the compositions by impregnation.

Among the uses mentioned, the treatment of exhaust gases from internal combustion engines (automobile afterburning catalysis) is a particularly advantageous application insofar as the compositions of the invention exhibit a high OSC at temperatures ranging at least up to 1000° C.

For this reason, the invention also relates to a process for the treatment of exhaust gases from internal combustion engines, which is characterized in that use is made, as catalyst, of a catalytic system as described above or of a composition according to the invention and as described above.

A more specific use of the composition of the invention will be described below.

Owing to the fact that it exhibits a high OSC at elevated temperature, that is to say between 1000° C. and 1100° C., but also an OSC which decreases markedly after calcination at a temperature of at least 1100° C., more particularly of at least 1200° C., over a duration of 10 hours, the composition of the invention can act as control. Specifically, its OSC can be regularly measured. If the OSC measured suddenly decreases, this then means that the system has been subjected to an elevated temperature, at least 1150° C., for a fairly lengthy time, at least a few hours.

In catalytic systems which comprise compositions, the OSC of which is capable of varying in a much less significant manner when they are exposed to temperatures of the order of 1200° C., the measurement of the OSC of these thus does not make it possible to know what the system was able to be subjected to as thermal stress during the use thereof. The presence of a composition according to the invention in these systems makes it possible to demonstrate the fact that the system has been subjected to elevated temperatures which may have brought about a deterioration in its properties.

For this reason, the invention also relates to an on-board diagnostic system which comprises only a composition according to the invention or else which is based on such a composition. This system additionally comprises a means, known per se, for measuring the OSC of the composition.

The invention also relates to an on-board diagnostic system as described above but which comprises, as first composition, a composition according to the invention and, in addition, a second composition which exhibits a variation in its OSC, measured, on the one hand, after calcination for 4 hours at 1000° C. and, on the other hand, for 10 hours at 1150° C., more particularly at 1200° C., which is markedly smaller than the variation in OSC of a composition according to the invention after calcination under the same conditions.

More particularly, this second composition can exhibit, after calcination for 10 hours at 1150° C., more particularly at 1200° C., an OSC which is at least twice as great as that of the composition according to the invention after calcination under the same conditions.

Such compositions are known; mention may in particular be made of those described in patent applications EP 2 288 426, EP 2 024 084, EP 1 991 354, EP 1 660 406 or EP 0 906 244.

Examples will now be given.

The methods for measuring the oxygen storage capacity and the maximum reducibility temperature are given below for these examples.

Measurement of Oxygen Storage Capacity

This measurement is carried out by performing a programmed temperature reduction on an Autochem II 2920 device. This device makes it possible to measure the hydrogen consumption of a composition according to the invention as a function of the temperature and to deduce therefrom the degree of reduction of the cerium or also the amount of labile oxygen or of stored oxygen as this amount corresponds to half the hydrogen consumption.

This measurement is carried out on samples which were calcined beforehand for 4 hours at 1000° C. or for 10 hours at 1200° C., as the case may be.

The measurement is carried out using hydrogen diluted to 10% by volume in argon with a flow rate of 30 ml/min.

The experimental protocol consists in weighing out 200 mg of the sample in a pre-tared container. The sample is subsequently introduced into a quartz cell containing quartz wool in the bottom. Finally, the sample is covered with quartz wool and positioned in the oven of the measuring device. A rise in temperature up to 900° C. is carried out with a rise gradient of 10° C./min under H₂ at 10 vol % in Ar.

The consumption of the hydrogen is calculated from the missing surface area of the hydrogen signal between 400° C. and 500° C.

Maximum Reducibility Temperature

The measurement is carried out with the same device and under the same conditions as those given above.

The scavenging of the hydrogen is calculated from the missing surface area of the hydrogen signal from the baseline at ambient temperature to the baseline at 900° C. The maximum reducibility temperature (temperature at which the scavenging of the hydrogen is maximum and where, in other words, the reduction of the cerium(IV) to give cerium(III) is also maximum and which corresponds to the maximum O₂ lability of the composition) is measured using a thermocouple placed at the heart of the sample.

### EXAMPLE 1

This example relates to a composition comprising 44.875% of zirconium, 44.875% of cerium, 4.875% of lanthanum, 4.875% of praseodymium and 0.5% of silica, these proportions being expressed as percentage by weight of the oxides ZrO₂, CeO₂, La₂O₃, Pr₆O₁₁ and SiO₂.

The necessary amount of solutions of zirconium nitrate (267 g/l as ZrO₂), of cerium nitrate (249 g/l), of lanthanum nitrate (469 g/l as La₂O₃) and of praseodymium nitrate (500 g/l as Pr₆O₁₁) is introduced into a stirred beaker and 1.1 ml of potassium methyl siliconate at 453 g/l as SiO₂ are introduced. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The solution obtained is placed in a stainless steel autoclave equipped with a stirrer. The temperature of the medium is brought to 115° C. for 35 minutes with stirring.

32 grams of lauric acid are added to the suspension thus obtained. The suspension is kept stirred for 1 hour.

The suspension is then filtered on a Büchner funnel and then the filtered precipitate is washed with aqueous ammonia solution.

The product obtained is subsequently brought to 700° C. for 4 hours under stationary conditions.

### EXAMPLE 2

This example relates to a composition comprising 44.10% of zirconium, 44.10% of cerium, 4.9% of lanthanum, 4.9% of praseodymium and 2% of silica, these proportions being expressed as percentage by weight of the oxides ZrO₂, CeO₂, La₂O₃, Pr₆O₁₁ and SiO₂.

The necessary amount of the solutions of zirconium nitrate, of cerium nitrate, of lanthanum nitrate and of praseodymium nitrate used for example 1 is introduced into a stirred beaker and 4.4 ml of potassium methyl siliconate at 453 g/l as SiO₂ are introduced. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### EXAMPLE 3

This example relates to a composition comprising 44.875% of zirconium, 44.875% of cerium, 4.875% of lanthanum, 4.875% of praseodymium and 0.5% of silica, these proportions being expressed as percentage by weight of the oxides ZrO₂, CeO₂, La₂O₃, Pr₆O₁₁ and SiO₂.

The necessary amount of the solutions of zirconium nitrate, of cerium nitrate, of lanthanum nitrate and of praseodymium nitrate used for example 1 is introduced into a stirred beaker and 3 ml of sodium silicate at 200 g/l as SiO₂ are introduced. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### EXAMPLE 4

This example relates to a composition comprising 74.9% of zirconium, 9.9% of cerium, 1.9% of lanthanum, 7.9% of yttrium, 4.9% of neodymium and 0.5% of silica, these proportions being expressed as percentage by weight of the oxides ZrO₂, CeO₂, La₂O₃, Y₂O₃, Nd₂O₃ and SiO₂.

The necessary amount of solutions of zirconium nitrate (267 g/l as ZrO₂), of cerium nitrate at 249 g/l, of lanthanum nitrate (469 g/l as La₂O₃), of neodymium nitrate (484 g/l as Nd₂O₃) and of yttrium nitrate (261 g/l as Y₂O₃) is introduced into a stirred beaker and 1.1 ml of potassium methyl siliconate at 453 g/l as SiO₂ are introduced. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### EXAMPLE 5

This example illustrates the preparation of a composition according to the invention by a process according to the fourth embodiment.

It relates to a composition comprising 74.9% of zirconium, 9.9% of cerium, 1.9% of lanthanum, 7.9% of yttrium, 4.9% of neodymium and 0.5% of silica, these proportions being expressed as percentage by weight of the oxides ZrO₂, CeO₂, La₂O₃, Y₂O₃, Nd₂O₃ and SiO₂.

Two solutions of nitrates are prepared beforehand, one consisting of cerium and zirconium nitrates and the other consisting of lanthanum, yttrium and neodymium nitrates. 0.39 l of water with 0.25 l of zirconium nitrate ([ZrO₂]=288 g/l and d=1.433) and also 0.04 l of cerium nitrate ([CeO₂]=246 g/l and d=1.43) are introduced into a first beaker. 76.6 ml of water, 4.1 ml of lanthanum nitrate ([La₂O₃]=471 g/l and d=1.69), 29.4 ml of yttrium nitrate ([Y₂O₃]=261 g/l and d=1.488) and 9.9 ml of neodymium nitrate ([Nd₂O₃]=484 g/l and d=1.743) are introduced into a second beaker, followed by 1.1 ml of potassium methyl siliconate at 453 g/l as SiO₂. The mixture is subsequently made up with distilled water, so as to obtain 1 liter of solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The two solutions prepared above are kept continually stirred. The first solution of cerium and zirconium nitrates is introduced into the reactor stirred at a speed of 500 rev/min, the second solution of nitrates is subsequently introduced and the stirring is set at 250 rev/min.

The solution obtained is placed in a stainless steel autoclave equipped with a stirrer.

The procedure is subsequently as in example 1.

### EXAMPLE 6

This example relates to a composition comprising a high cerium content. The proportions are as follows: 9.95% of zirconium, 79.6% of cerium, 2.985% of lanthanum, 6.965% of praseodymium and 0.5% of silica, these proportions being expressed as percentage by weight of the oxides ZrO₂, CeO₂, La₂O₃, Pr₆O₁₁ and SiO₂.

The necessary amount of zirconium nitrate (267 g/l as ZrO₂), of cerium nitrate at 249 g/l, of lanthanum nitrate (469 g/l as La₂O₃) and of praseodymium nitrate (500 g/l as Pr₆O₁₁) is introduced into a stirred beaker, followed by 1.1 ml of potassium methyl siliconate at 453 g/l as SiO₂. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### COMPARATIVE EXAMPLE 7

This example relates to a composition comprising 45% of zirconium, 45% of cerium, 5% of lanthanum and 5% of praseodymium, these proportions being expressed as percentage by weight of the oxides ZrO₂, CeO₂, La₂O₃ and Pr₆O₁₁.

The necessary amount of the solutions of zirconium nitrate, of cerium nitrate, of lanthanum nitrate and of praseodymium nitrate used for example 1 is introduced into a stirred beaker. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### COMPARATIVE EXAMPLE 8

This example relates to a composition comprising 75% of zirconium, 10% of cerium, 2% of lanthanum, 8% of yttrium and 5% of neodymium, these proportions being expressed as percentage by weight of the oxides ZrO₂, CeO₂, La₂O₃, Y₂O₃ and Nd₂O₃.

The necessary amount of the solutions of zirconium nitrate, of cerium nitrate, of lanthanum nitrate, of neodymium nitrate and of yttrium nitrate used for example 4 is introduced into a stirred beaker. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

### COMPARATIVE EXAMPLE 9

This example relates to a composition comprising 10% of zirconium, 80% of cerium, 3% of lanthanum and 7% of praseodymium, these proportions being expressed as percentages by weight of the oxides ZrO₂, CeO₂, La₂O₃ and Pr₆O₁₁.

The necessary amount of zirconium nitrate (267 g/l as ZrO₂), of cerium nitrate at 249 g/l, of lanthanum nitrate (469 g/l as La₂O₃) and of praseodymium nitrate (500 g/l as Pr₆O₁₁) is introduced into a stirred beaker. The mixture is subsequently made up with distilled water, so as to obtain 1 liter of a solution of nitrates.

An aqueous ammonia solution (12 mol/l) is introduced into a stirred reactor and the mixture is subsequently made up with distilled water, so as to obtain a total volume of 1 liter and a stoichiometric excess of ammonia of 40%, with respect to the nitrates to be precipitated.

The solution of nitrates is introduced into the reactor with continual stirring.

The procedure is subsequently as in example 1.

The specific surfaces of the products of the examples are given in table 1 below.

TABLE 1

Specific surface (m²/g) after
calcination for 4 hours at

| Example | 1000° C. | 1100° C. |
|---|---|---|
| 1 | 41 | 20 |
| 2 | 45 | 21 |
| 3 | 43 | 21 |
| 4 | 38 | 12 |
| 5 | 45 | 19 |
| 6 | 33 | 19 |
| 7, comparative | 49 | 27 |
| 8, comparative | 51 | 23 |
| 9, comparative | 30 | 19 |

The reducibility characteristics of the products of the examples are given in table 2 below.

TABLE 2

| | Tmax (° C.) | | OSC | | |
|---|---|---|---|---|---|
| | 1000° | 1200° | 1000° | 1200° | Variation in |
| Example | C. | C. | C. | C. | the OSC (%) |
| 1 | 575 | 824 | 0.92 | 0.08 | 91 |
| 2 | 580 | 850 | 0.72 | 0.1 | 98 |
| 3 | 568 | 780 | 0.93 | 0.15 | 83 |
| 4 | 571 | 800 | 0.35 | 0.05 | 86 |
| 5 | 558 | 758 | 0.3 | 0.06 | 80 |
| 6 | 570 | 760 | 0.275 | 0.05 | 82 |
| 7, comparative | 569 | 654 | 0.97 | 0.36 | 63 |
| 8, comparative | 574 | 660 | 0.35 | 0.14 | 60 |
| 9, comparative | 560 | 580 | 0.28 | 0.20 | 29 |

The temperatures which appear in the Tmax and OSC columns are the temperatures at which the products, the Tmax and OSC values of which were measured, were calcined for 4 hours (1000° C.) or 10 hours (1200° C.).

The variation in the OSC is the decrease in OSC measured on the products calcined at 1000° C. or at 1200° C.

It is observed that the products of the invention exhibit Tmax values and OSC values which are comparable, after calcination at 1000° C., with those of the comparative products with similar compositions.

In contrast, the comparative products see their Tmax vary within an amplitude of approximately 100° C. between those calcined at 1000° C. and those calcined at 1200° C., whereas, for the products of the invention, this amplitude is at least approximately 170° C. and it can be greater than 200° C. The variation in the OSC is approximately 60% for the comparative products, whereas it is at least 80% for the products of the invention.

1. A composition based on zirconium oxide, cerium oxide and at least one oxide of a rare earth metal other than cerium, wherein the composition comprises: at least 5% by weight zirconium oxide, cerium oxide in an amount of less than 90% by weight, and silicon oxide in an amount between 0.1% and 2% by weight.

2. The composition as claimed in claim 1, wherein the composition comprises the silicon oxide in an amount between 0.1% and 1% by weight.

3. The composition as claimed in claim 1, wherein the composition comprises the silicon oxide in an amount between 0.1% and 0.6% by weight.

4. The composition as claimed in claim 1, wherein the composition comprises the cerium oxide in an amount between 30% and 60% by weight.

5. The composition as claimed in claim 1, wherein the composition comprises the cerium oxide in an amount between 5% and 20% by weight.

6. The composition as claimed in claim 1, wherein the composition comprises the at least one oxide of the rare earth metal other than cerium in an amount between 5% and 25% by weight.

7. The composition as claimed in claim 1, wherein the composition exhibits, after calcination for 4 hours at 1000° C. and then calcination for 10 hours at 1200° C., a decrease in its oxygen storage capacity (OSC) of at least 80%, more particularly of at least 90%.

8. The composition as claimed in claim 1, wherein the composition exhibits, after calcination for 4 hours at 1000° C., an OSC of at least 0.6 ml O₂/g when the composition comprises cerium oxide in an amount between 30% and 60% by weight, and an OSC of at least 0.2 ml O₂/g when the composition comprises cerium oxide in an amount between 5% and 15% or at least 70% by weight.

9. The composition as claimed in claim 1, wherein the composition exhibits, after calcination for 4 hours at 1000° C. and then calcination for 10 hours at 1200° C., an increase in its maximum reducibility temperature of at least 150° C.

10. A process for the preparation of a composition as claimed in claim 1, wherein the process comprises:
(a1) forming a mixture comprising compounds of zirconium, cerium, at least one rare earth metal other than cerium and silicon;
(b1) contacting said mixture with a basic compound, whereby a precipitate is obtained;
(c1) heating said precipitate in a liquid medium;
(d1) contacting the precipitate obtained in (c1) with at least one additive chosen from anionic surfactants, non-ionic surfactants, polyethylene glycols, carboxylic acids and their salts, and surfactants of the carboxymethylated fatty alcohol ethoxylate type;
(e1) calcining the product thus obtained in (d1).

11. A process for the preparation of a composition as claimed in claim 1, wherein the process comprises:
(a2) forming a mixture comprising compounds of zirconium, cerium and at least one rare earth metal other than cerium;
(b2) contacting said mixture with a basic compound, whereby a precipitate is obtained;
(c2) heating said precipitate in a liquid medium;
(d2) adding a silicon compound to the precipitate obtained in (c2);
(e2) contacting the product obtained in (d2) with at least one additive chosen from anionic surfactants, non-ionic surfactants, polyethylene glycols, carboxylic acids and their salts, and surfactants of the carboxymethylated fatty alcohol ethoxylate type, wherein (d2) and (e2) are optionally carried out at the same time;
(f2) calcining the product thus obtained in (e2).

12. A process for the preparation of a composition as claimed in claim 1, wherein the process comprises:
(a3) forming a mixture comprising compounds of zirconium, cerium, at least one rare earth metal other than cerium and optionally a silicon compound;
(b3) heating said precipitate in a liquid medium;
(c3) contacting the heated precipitate from (b3) with a silicon compound, if the silicon compound was not present in (a3);
(d3) contacting the product obtained in (c3) with at least one additive chosen from anionic surfactants, non-ionic surfactants, polyethylene glycols, carboxylic acids and their salts, and surfactants of the carboxymethylated fatty alcohol ethoxylate type, wherein (c3) and (d3) are optionally carried out at the same time;
(e3) calcining the product obtained in (d3).

13. A process for the preparation of a composition as claimed in claim 1, wherein the process comprises:
(a4) forming a mixture comprising:
compounds of zirconium, cerium and silicon only, or
a mixture of compounds of zirconium, cerium, silicon and one or more rare earth metals other than cerium in an amount of compound(s) less than the amount necessary to obtain the composition;
(b4) contacting said mixture is brought together, with stirring, with a basic compound;
(c4) contacting the mixture obtained in (b4), with stirring, either:
with the compound or compounds of rare earth metals other than cerium, if this or these compounds were not present in (a4), or
with the remaining amount of said compound or compounds necessary to obtain the composition,
the stirring energy used during stage (c4) being less than that used during stage (b4), whereby a precipitate is obtained;
(d4) heating said precipitate in an aqueous medium;
(e4) contacting the precipitate obtained in (d4) with at least one additive chosen from anionic surfactants, non-ionic surfactants, polyethylene glycols, carboxylic acids and their salts, and surfactants of the carboxymethylated fatty alcohol ethoxylate type;
(f4) calcining the precipitate thus obtained in (e4).

14. The process as claimed in claim 10, wherein the compounds of zirconium, cerium and the other rare earth metals are selected from nitrates, sulfates, acetates, chlorides, ceric ammonium nitrate and mixtures thereof.

15. The process as claimed in claim 10, wherein the silicon compounds, are selected from siliconates, alkali metal silicates, quaternary ammonium silicates and mixtures thereof.

16. The process as claimed in claim 10, wherein the heating of the precipitate from (c1), (c2), (b3) or (d4) is carried out at a temperature of at least 100° C.

17. A catalytic system, characterized in that it comprises a composition as claimed in claim 1.

18. An on-board diagnostic system, characterized in that it comprises a composition as claimed in claim 1.

19. The system as claimed in claim 18, wherein the system further comprises a second composition which exhibits, after calcination for 10 hours at 1150° C., an OSC which is at least twice as great as that of the composition as claimed in claim 1 after calcination under the same conditions.

20. A process for the treatment of exhaust gases from internal combustion engines, the process comprising contacting an exhaust gas with the catalytic system as claimed in claim 17.
